(19) United States
(12) Patent Application Publication
(10) Pub. No.: US 2025/0269410 A1
(43) Pub. Date: Aug. 28, 2025

(54) TANK CLEANING ARRANGEMENT

(71) Applicant: B/E Aerospace, Inc., Winston Salem, NC (US)

(72) Inventors: Piotr Jacek Kroczek, NIECISZÓW (PL); Lukasz Turek, Wroclaw (PL)

(73) Assignee: B/E Aerospace, Inc., Winston Salem, NC (US)

(21) Appl. No.: 19/056,189

(22) Filed: Feb. 18, 2025

(30) Foreign Application Priority Data
Feb. 23, 2024 (EP) 24461531.6

(51) Int. Cl. B08B 9/08; B64F 5/30

(52) U.S. Cl. CPC B08B 9/0804; B08B 2209/08; B64F 5/30

(57) ABSTRACT

A cleaning arrangement for cleaning the interior of a tank containing fluid, the cleaning arrangement comprising: a pneumatic distributor having a pneumatic fluid input and a plurality of pneumatic fluid outputs and configured to selectively route pneumatic fluid from the input to the outputs, each of the outputs configured to provide fluid to an interior of the tank via a respective port in a wall of the tank according to the selectively routed distribution of fluid to create a variable vortex in the tank interior

### CROSS-REFERENCE TO RELATED APPLICATIONS

This application claims priority to EP patent application Ser. No. 24461531.6, filed Feb. 23, 2024 and titled “TANK CLEANING ARRANGEMENT,” which is incorporated by reference herein in its entirety for all purposes.

### FIELD

The present disclosure relates to ways of cleaning the interior of a tank such as, but not exclusively, a waste water tank e.g. in an aircraft.

### BACKGROUND

Tanks or reservoirs containing matter such as waste water from a sanitation system, or other matter, which may be contaminated or hazardous or generally undesirable if left on the inner surfaces of the tank for a period of time often include a device that extends into and sprays water or some cleaning fluid around the tank to clean the tank. This can avoid the need for manual cleaning of the tank which can be unpleasant or even dangerous. Furthermore, the tanks are often too small to enable a person to access the interior to clean it properly, or the tank may be vacuum sealed and so not accessible for manual cleaning and/or access to the tanks may be too difficult for the tank to be cleaned by a person. Passenger aircraft include large tanks for human waste from the aircraft toilets. These tanks are emptied after a flight and the inside of the tank is cleaned. This is usually done by means of a device, known as a rinse nipple, having nozzles through which pressurized water or a cleaning solution is sprayed around the interior of the tank.

A conventional rinse nipple includes a rinse valve to which a rinse hose providing the cleaning fluid is connected. The rinse valve extends through the tank wall. A rinse head is provided at the end of the housing located inside the tank. The rinse head is provided with multiple openings or nozzles and the pressurized fluid is ejected out through the nozzles to clean the tank. Some rinse nipples have a rotatable rinse head. To avoid the need for power to be supplied to rotate the rinse head, the openings or nozzles are angled and offset relative to the axis of rotation of the head. This positioning provides momentum about the axis to cause the head to spin about the axis thus maximizing the coverage of the fluid inside the tank.

Whilst the multiple nozzles and spinning head ensures that the fluid is sprayed as much as possible around the tank interior, due to the presence of various components and fittings that may be provided on the tank walls, extending to the tank interior, there may be some areas that are effectively obstructed or hidden by these components and are not reached by the spray from the spinning head. Furthermore, particularly when the tanks are large. The fluid may not reach all parts of the interior of the tank, and may not reach the bottom with sufficient force to provide effective cleaning. This can result in waste material or the like remaining in those areas where the pressurized fluid does not reach, and clogging or building up. The tank cannot, therefore, be fully purged of all of the waste, which can cause contamination of the tank. There is, therefore, a need for a cleaning arrangement that can ensure that a greater area of the tank interior is contacted by the cleaning fluid.

### SUMMARY

According to the present disclosure, there is provided a cleaning arrangement for cleaning the interior of a tank containing fluid, the cleaning arrangement comprising: a pneumatic distributor having a pneumatic fluid input and a plurality of pneumatic fluid outputs and configured to selectively route pneumatic fluid from the input to the outputs, each of the outputs configured to provide fluid to an interior of the tank via a respective port in a wall of the tank according to the selectively routed distribution of fluid to create a variable vortex in the tank interior.

A tank including such arrangements, and a cleaning method are also provided.

### BRIEF DESCRIPTION OF THE DRAWINGS

Examples of the cleaning arrangement according to this disclosure will be described with reference to the drawings. It should be noted that these are merely examples and variations are possible within the scope of the claims.

FIG. 1 shows an example of a known tank and rinse arrangement for the purposes of explanation;

FIG. 2 is shown to explain the problem of the known device such as shown in FIG. 1;

FIG. 3 shows an example of a cleaning arrangement according to the disclosure;

FIG. 4 is a cross-sectional view of a tank with a cleaning arrangement according to the disclosure;

FIG. 5 is a sectional view at A-A into a tank such as shown in FIG. 4;

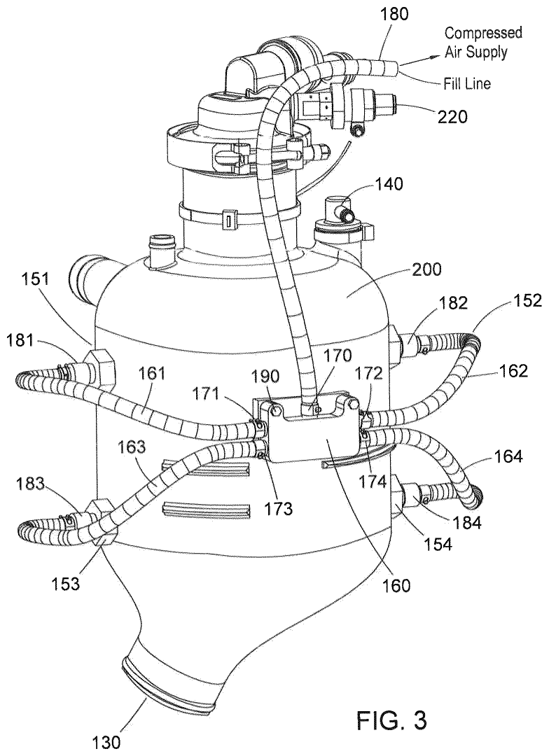

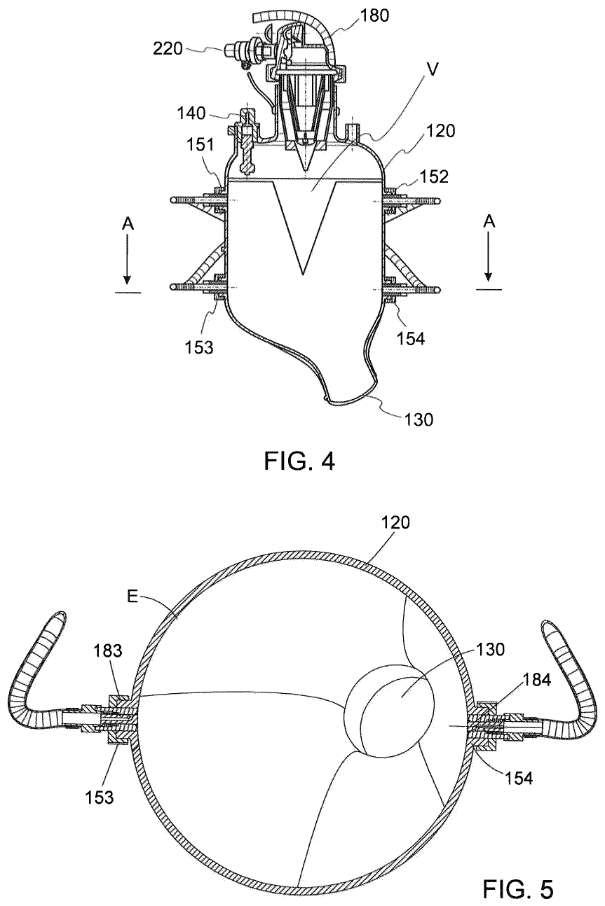

FIGS. 4, 6A and 6B are cross-sectional views of a tank such as shown in FIG. 3 at different stages of operation of a cleaning arrangement according to the disclosure;

FIGS. 7A to 7D are illustrated to explain the travel of vortexes that can be obtained using a cleaning arrangement according to the disclosure;

FIG. 8 is a cross-sectional view of a port and nozzle forming part of a cleaning arrangement according to the disclosure in a first position; and

FIG. 9 is a cross-sectional view of a port and nozzle forming part of a cleaning arrangement according to the disclosure in a second position.

### DETAILED DESCRIPTION

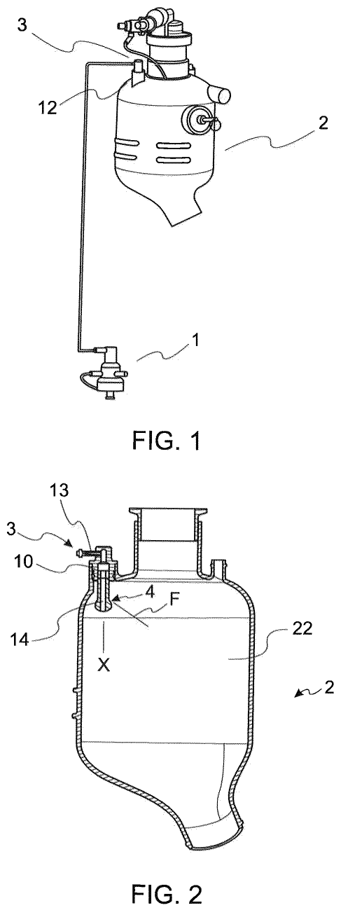

A typical rinse device is shown in FIGS. 1 and 2. A rinse nozzle 3 is shown mounted in the wall 12 of a tank 2 or vat or other reservoir. The rinse nozzle 3 is connected, in use, to a rinse port 1 from which rinse fluid is provided to the rinse nozzle from a rinse fluid supply (not shown). FIG. 2 shows, in cross-section, the rinse nozzle 3 mounted in the wall 12 of the tank 2, at the top of the tank. Apertures or jets 4 are formed in the nozzle 3 such that as rinse fluid is provided to the nozzle 3 it is sprayed out through the jets 4 around the interior 22 of the tank to clean the tank. A typical nozzle 3 comprises a housing 10, one end of which is provided with a fitting 13 arranged to be attached to a pipe or the like via which pressurized water or cleaning solution is provided. At the other end of the housing through which the pressurized fluid flows, which extends into the tank, is mounted a rinse head 14 mounted to rotate relative to the housing 10. The rinse head is arranged to rotate about an axis of rotation X which is the axis through the housing from the one end to the other end.

The rinse head 14 is provided with a number of holes or jets 4 via which the pressurized fluid F forced through the housing is ejected into the tank. The jets can be positioned offset from the axis of rotation and at angles such that the ejection of the pressurized fluid F provides a force that causes the rinse head 14 to rotate relative to the housing about the axis X.

The pressurization of the fluid and the rotation of the rinse head provides a good range of coverage of the interior of the tank with cleaning fluid. In some cases, however, areas may exist, due to the presence of other components on the inside of the tank, that fluid from the rinse head cannot reach. Alternatively, because the rinse nozzle is typically small and mounted into the top of the tank, the pressurized fluid F may not adequately reach the bottom or other locations in the interior of the tank, or at least not with sufficient force to adequately clean the tank. Furthermore, as can be seen in FIG. 2, the jets do not clean the tank in a symmetrical manner.

The cleaning arrangement according to this disclosure is designed to address these problems as will be described with reference to FIGS. 3 to 9. The arrangement will be described in relation to a tank similar to that shown in FIG. 1, for ease of explanation. It should be noted that the cleaning arrangement may be used with other types of tank of reservoir having an interior to be cleaned.

FIGS. 2 and 3 show an example of a tank 200 to which a cleaning arrangement according to this disclosure can be mounted. As with the tank of FIG. 1, the tank has a tank wall 120 defining the tank interior volume, a waste or other fluid inlet port 220 via which the tank contents e.g. waste, enter the tank and a drain port 130 via which the content exits the tank when the tank is emptied.

The cleaning arrangement according to the disclosure is configured to create a moving or variable vortex within the interior of the tank, as will be described further below. The tank can then be filled with water and/or cleaning fluid and a moving/variable vortex is created within the tank interior to generate movement of the water/cleaning fluid around the tank and to cause the water/cleaning fluid to impact different parts of the interior wall of the tank with different pressures to ensure thorough cleaning.

This cleaning process may be performed by first draining the waste from the tank, via the drain 130, and then filling the tank with clean/rinse water or other fluid, which may or may not include other cleaning or detergent fluids or substances. The cleaning arrangement is then operated to create the moving/varying vortex to clean the tank. The cleaning fluid/water can be introduced, as is known, through a rinse fluid input 140. This may be a simple port connected to a hose or the like to supply the fluid into the tank or may be in the form of a known rinse nozzle to spray water or fluid into the tank. Either way, the moving vortex creates movement of the fluid around the interior tank wall.

To create the moving vortex, the tank has to be modified to have four or more ports 151, 152, 153, 154 extending through the tank wall 120. The cleaning arrangement of the disclosure comprises a pneumatic distributer 160 having a compressed air input 170 and four (or more) compressed air outputs 171, 172, 173, 174. The compressed air input 170 is configured to receive compressed air from a compressed air supply e.g. via a fill line 180. Each of the compressed air outputs is configured to be fluidly connected to a respective one of the ports 151, 152, 153, 154 in the wall of the tank e.g. via a respective tube or pipe 161, 162, 163, 164 or other fluid conduit each of the conduits having a nozzle 181, 182, 183, 184 extending from the conduits, through the port.

The pneumatic distributor 160 is a compressed air distribution or junction box that selectively routes air from the input 170 to the four outputs 171, 172, 173, 174.

The pneumatic distributor may be mounted to the outer wall of the tank and attached thereto by e.g. screws 190 or other fasteners or straps or by adhesive. Alternatively, the distributor may be separate from the tank. The vortex-based cleaning process is initiated and sustained by compressed air entering the tank via the nozzles 181, 182, 183, 184 distributed amongst the nozzles according to the distributer 160. The different distribution of compressed air to the different nozzles creates the variation in the vortex V, seen in FIG. 4, inside the tank.

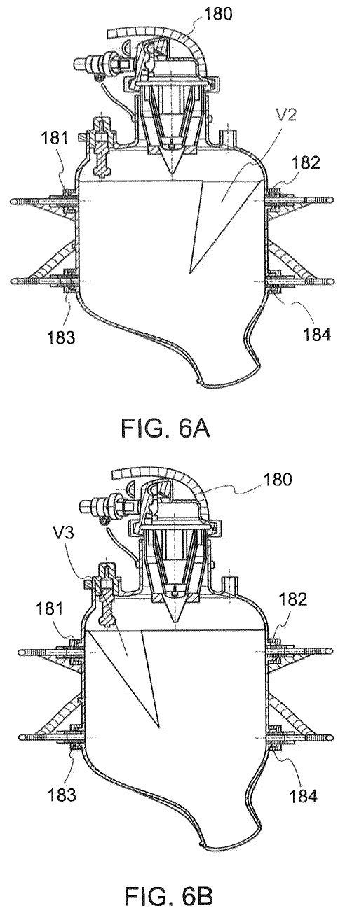

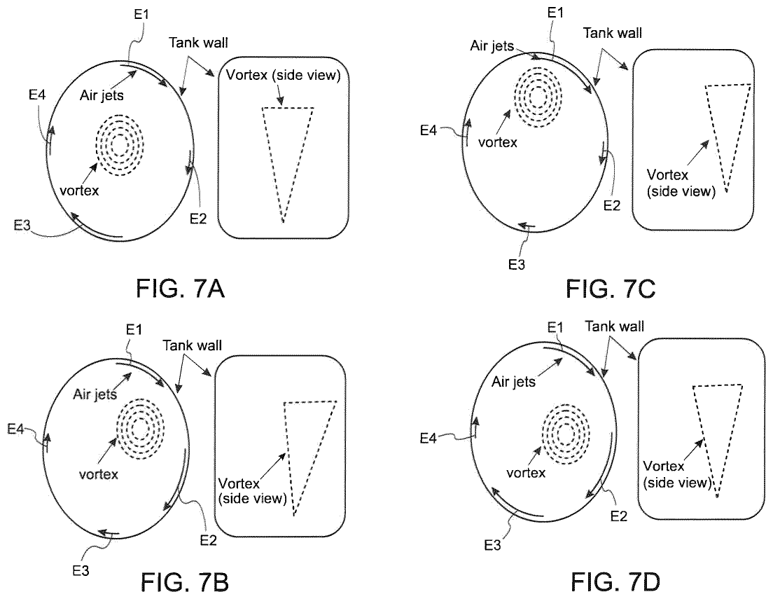

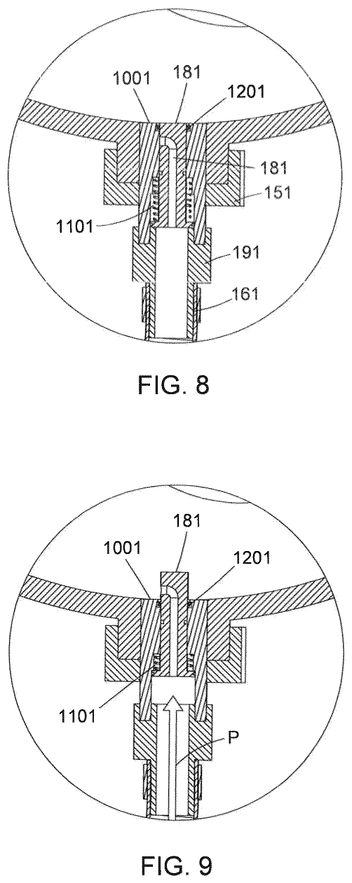

FIG. 5 shows, by arrows E, compressed air provided to the interior of the tank via nozzles 183 and 184 at ports 153 and 154, by way of example. Here the arrows indicate that the air pressure provided via each of the two nozzles is substantially equal but the flow from one nozzle is in the opposite direction that that of the other nozzle. Such a distribution of the compressed air would result in a spin vortex V such as shown in FIG. 4.

As can be seen from the examples in FIGS. 4, 6A and 6B, different vortexes can be created by changing the distribution of pressure at the four ports.

FIG. 4 shows a vortex V1 shows an example of a vortex that may be generated, for example, by providing the same pressure to all four nozzles 181, 182, 183, 184. FIG. 6A shows an example of a vortex V2 that may be generated, for example, by providing more or all of the pressure at diagonally opposing nozzles 182, 183 or 181 and 184. The vortex angle can be varied by activating only some of the nozzles or by providing more pressure to some nozzles than others (e.g. V3 shown in FIG. 6B).

The shape or angle of orientation of the vortex V and its spin speed can be easily adjusted by the pneumatic distributer 160 varying the distribution of pressure between the four nozzles and/or by selective activation of the nozzles.

Cleaning coverage is improved if a combination of these different vortexes is used during the cleaning process. This can be seen and explained with reference to FIGS. 7A to 7D where the jets of air from the four nozzles are indicated by arrows E1-E4. As a first example, shown in FIG. 7A, jets E1 and E3 have a high pressure and jest E2 and E4 have lower pressure. This generates a substantially central vortex having a shape as shown in the side view. If jets E1 and E2 have the greater pressure and E3 and E4 have the smaller pressure, the vortex moves up and to the right as seen in FIG. 7B. If jet E1 has a large pressure and E2, E3, and E4 are all smaller, the vortex moves towards E1 as seen in FIG. 7C. If E1, E2 and E3 are all high pressure and E4 is low pressure, the vortex moves to the bottom right of the image as seen in FIG. 7D. It can be seen, therefore, how the vortex can move around from the middle of the interior of the tank and then around the tank wall to clean the entire tank interior. If the vortex reaches a high speed close to the wall, it can also create a local cavitation effect which can also improve the cleaning effect.

The cleaning effect can be further enhanced by adding abrasive particles to the cleaning fluid or to the pressurized air provided by the cleaning arrangement via the nozzles. The particles will be caused to spin in the vortex and impact the walls to act essentially as a brush or scourer to blast waste/debris from the tank wall.

Although an example has been described using four ports/four nozzles, it should be appreciated that other numbers of ports and nozzles may also be used. The larger the system, the more, and larger, nozzles can be used and the greater the pressure that can be applied.

An example of the nozzles 181, 182, 183, 184 via which the pressurized air is jetted into the tank at the ports is shown in FIGS. 8 and 9. Only one nozzle and one port is shown, but it will be understood that the same design is suitable for all nozzles of the assembly.

The nozzle 181 is mounted to the conduit from the distributer output by means of a connector 191 fitted to the conduit 161. The connector can be fitted to the conduit in any known way to ensure a sealed fitting. The nozzle 181 is mounted in a nozzle housing 1001 and is biased in the housing in a retracted position, shown in FIG. 8, by a spring 1101. Seals 1201 may be provided between the nozzle and its housing to prevent the ingress of debris or contaminants. When the nozzle is not activated to provide pressurized air into the tank, it remains in this biased, retracted position to keep the nozzle clean.

To deploy the nozzle 181, as shown in FIG. 9, pressurized air is routed by the distributer via the corresponding air output 171 of the distributer, via the conduit 161 and the connector 191 to the nozzle 181, The air pressure P overcomes the force of the spring 1101 to extend the nozzle from the housing into the tank interior and the air is ejected from the nozzle into the tank as described above. Once the cleaning process is completed/that nozzle is no longer activated, the air pressure P is reduced and so the spring force brings the nozzle back to the retracted position of FIG. 8.

The seal 1201 may be a lip seal that acts to wipe water drops from the nozzle is its is pulled past the seal.

The cleaning assembly of this disclosure can be easily incorporated into existing tanks without being restricted by the rinse nozzle design and location. Unlike the rinse nozzle, which needs to be located at an uppermost part of the tank, there is more freedom in the location of the ports and nozzles of the present solution. Because the moving vortex solution can effect through cleaning of the entire tank interior using water in the tank, the cleaning process can use just the amount of water that can be contained within the volume of the tank and so the amount of water consumed using this solution as well as the amount of detergent or the like is typically less than for other rinse processes.

A further advantage of the cleaning assembly of this disclosure is that there is no need for additional fittings or components inside the tank and so no additional sources of debris collection or contamination or obstruction to the cleaning process.

The cleaning assembly is mechanically simple and clean and can be easily scaled to different sized tanks.

1. A cleaning arrangement for cleaning the interior of a tank containing fluid, the cleaning arrangement comprising: a pneumatic distributor having a pneumatic fluid input and a plurality of pneumatic fluid outputs and configured to selectively route pneumatic fluid from the input to the outputs, each of the outputs configured to provide fluid to an interior of the tank via a respective port in a wall of the tank according to the selectively routed distribution of fluid to create a variable vortex in the tank interior.

2. The cleaning arrangement of claim 1, wherein the distributer is configured to selectively vary the distribution of the pneumatic fluid between the outputs during a cleaning process to cause the generated vortex to move around the interior of the tank.

3. The cleaning arrangement of claim 1, further comprising a fluid nozzle fluidly connected to each of the fluid outputs, each of the nozzles configured to extend through a respective one of the ports in the wall of the tank.

4. The cleaning arrangement of claim 3, wherein nozzles are retractably mounted relative to the respective ports.

5. The cleaning arrangement of claim 4, wherein each nozzle is mounted within a housing and is biased by means of a spring to a retracted position within the housing, wherein the nozzle is forced to extend from the housing into the tank interior when the pressure (P) of pneumatic fluid routed to that nozzle from the fluid distributor exceeds the force of the spring.

6. The cleaning arrangement of claim 5, further comprising a seal between the nozzle and the housing.

7. The cleaning arrangement of claim 1, further comprising a fill line connected to the input of the distributer and configured to be connected to a supply of pneumatic fluid.

8. The cleaning apparatus of claim 1, wherein the pneumatic fluid is air.

9. The cleaning arrangement of claim 1, wherein the pneumatic fluid contains abrasive particles.

10. The cleaning arrangement of claim 1, further comprising a fluid conduit connected to each of the outputs of the distributer and configured to be in fluid communication with a respective one of the ports in the wall of the tank.

11. The cleaning arrangement of claim 1, comprising four outputs of the distributer and four ports in the wall of the tank.

12. A tank defining an interior volume to be cleaned, the tank comprising a cleaning arrangement as claimed in claim 1.

13. The tank of claim 12, wherein the distributer is mounted to an exterior of the tank.

14. The tank of claim 12 comprising a waste inlet and a drain and containing water for the cleaning process.

15. A method of cleaning an interior of a tank comprising:
mounting a cleaning arrangement as claimed in claim 1 to the tank, draining waste from the tank, filling the tank with fluid, controlling the routing of the pneumatic fluid to the ports in the wall of the tank via the distributor to create a vortex that moves around the interior of the tank.
